(19) United States
(12) Patent Application Publication
(10) Pub. No.: US 2023/0408708 A1
(43) Pub. Date: Dec. 21, 2023

(54) LOCATION INFORMATION OBTAINING METHOD AND LOCATION INFORMATION OBTAINING APPARATUS

(71) Applicants: Hyundai Motor Company, Seoul (KR); Kia Corporation, Seoul (KR)

(72) Inventors: Yunjoong PARK, Seoul (KR); Jeongtaek OH, Yongin-si (KR); Byeonghwi CHOI, Suwon-si (KR)

(21) Appl. No.: 17/973,017

(22) Filed: Oct. 25, 2022

(30) Foreign Application Priority Data
May 24, 2022 (KR) 10-2022-0063654

(51) Int. Cl. G01S 19/49

(52) U.S. Cl. CPC G01S 19/49; G06Q 30/0284

(57) ABSTRACT

A location information obtaining apparatus of a vehicle includes a navigation device configured to obtain first GPS information using at least one of a GPS navigation and a DR navigation, a map matching feedback module configured to feedback second GPS information generated by map matching between the first GPS information and map data to the navigation device, and an application device configured to determine a current location of the vehicle based on the first GPS information received from the navigation device.

### CROSS-REFERENCE TO RELATED APPLICATION

The present application claims priority to Korean Patent Application No. 10-2022-0063654 filed on May 24, 2022, the entire contents of which is incorporated herein for all purposes by this reference.

### BACKGROUND OF THE PRESENT DISCLOSURE

### Field of the Present Disclosure

The present disclosure relates to a location information obtaining method and a location information obtaining apparatus.

### Description of Related Art

A location information obtaining apparatus mounted on a vehicle, such as a navigation system, generally obtains current location information of a vehicle through a map matching operation that matches global positioning system (GPS) information on a map.

The GPS is a satellite navigation system that calculates a user's current location by receiving signals from GPS satellites. Therefore, there are sections in which it is difficult to receive GPS signals normally, such as tunnels, underpasses, and underground parking lots, and it is difficult for a location information obtaining apparatus of a vehicle which enters the GPS shaded section to obtain the current location of the vehicle only with GPS information. Accordingly, when a vehicle enters a GPS shaded section while using a route guidance service, a current location of the vehicle is specified as a wrong location or a wrong route is guided, and thus, when the vehicle is out of the GPS shaded section, a situation of re-searching a route occurs.

Accordingly, various methods of estimating a current location of a vehicle in a GPS shaded section where it is difficult to receive a GPS signal have been proposed.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a location information obtaining apparatus and a taxi service providing system including the same having advantages of improving location estimation accuracy of a vehicle entering a GPS shaded section.

An exemplary embodiment of the present disclosure provides a location information obtaining apparatus of a vehicle, including: a navigation device configured to obtain first GPS information using at least one of a GPS navigation using a global positioning system (GPS) signal and a dead reckoning (DR) navigation using speed information and direction information of the vehicle; a map matching feedback module configured to feedback second GPS information generated by map matching between the first GPS information and map data to the navigation device; and an application device configured to determine a current location of the vehicle based on the first GPS information received from the navigation device. An activation of the map matching feedback module may be controlled according to a location in a GPS shaded section of the vehicle or a driving distance of the vehicle in the GPS shaded section, and the navigation device may generate third GPS information using the first GPS information and the second GPS information when the map matching feedback module is activated, and transmit any one of the first GPS information and the third GPS information to the application device according to whether the map matching feedback module is activated.

The map matching feedback module may be activated when the vehicle enters the GPS shaded section and then drives more than a predetermined distance within the GPS shaded section, and is deactivated when the vehicle is out of the GPS shaded section.

The navigation device may use the DR navigation to obtain the first GPS information when the vehicle enters the GPS shaded section.

When the map matching feedback module is activated, the navigation device may obtain the third GPS information by correcting the first GPS information using the second GPS information, and transmit the third GPS information to the application device.

The navigation device may transmit the first GPS information to the application device when the map matching feedback module is deactivated.

The application device may determine the current location of the vehicle on the map data by map matching between the first GPS information received from the navigation device and the map data.

The application device may determine whether the vehicle enters the GPS shaded section and the driving distance driven by the vehicle within the GPS shaded section based on the GPS information and the map data received from the navigation device.

The activation of the map matching feedback module may be controlled according to presence or absence of a junction in the GPS shaded section and a distance between the vehicle and the junction.

The map matching feedback module may be deactivated when the junction exists in the GPS shaded section and the vehicle is located within a predetermined distance from the junction.

The application device may determine whether the junction exists in the GPS shaded section based on the first GPS information received from the navigation device and the map data, and determine the distance between the junction and the vehicle.

The location information obtaining apparatus may further include a sensor device configured to detect wheel speed and direction of the vehicle, in which the navigation device may obtain speed information and direction information of the vehicle based on information detected by the sensor device.

The GPS shaded section may be a tunnel or an underpass section.

Another exemplary embodiment of the present disclosure provides a taxi service providing system, including: the location information obtaining apparatus, in which the application device and the map matching feedback module may be included in an integrated terminal of the taxi service providing system, and the integrated terminal may be connected to, through a network, an operation server that provides a response to a request for a service received from a user terminal, determine whether to check dispatch call information by use of information linking a driving state of the vehicle, a user's boarding location, and heading direction information of the vehicle, determine a driving fee by use of GPS information or wheel speed information of the vehicle, and determine whether to change an output screen of the vehicle through gear state information of the vehicle.

Another exemplary embodiment of the present disclosure provides a location information obtaining method of a vehicle, including: obtaining first GPS information using at least one of a GPS navigation using a GPS signal and a DR navigation using speed information and direction information of the vehicle; controlling an activation of a map matching feedback module that generates second GPS information by map matching of the first GPS information and map data according to a location in a GPS shaded section of the vehicle or a driving distance of the vehicle in the GPS shaded section; when the map matching feedback module is activated, generating third GPS information using the first GPS information and the second GPS information; and determining a current location of the vehicle by use of any one of the first GPS information and the third GPS information according to whether the map matching feedback module is activated.

The obtaining of the first GPS information may include: when the vehicle is located in the GPS shaded section, obtaining the first GPS information using the DR navigation.

The obtaining of the first GPS information may include: when the vehicle is located outside the GPS shaded section, obtaining the first GPS information using the GPS navigation.

The controlling of the activation may include: activating the map matching feedback module when the vehicle is located in the GPS shaded section and the driving distance driven by the vehicle within the GPS shaded section is greater than or equal to a predetermined distance; and when the vehicle is located outside the GPS shaded section, deactivating the map matching feedback module.

The location information obtaining method may further deactivating the map matching feedback module according to presence or absence of a junction in the GPS shaded section and a distance between the vehicle and the junction.

The deactivating may include deactivating the map matching feedback module when the junction exists in the GPS shaded section and the vehicle is located within a predetermined distance from the junction.

The determining of the current location may include determining the current location of the vehicle on the map data through the map matching of the map data with any one of the first GPS information and the third GPS information.

According to an exemplary embodiment of the present disclosure, it is possible to improve location estimation accuracy of a vehicle entering a GPS shaded section. Furthermore, according to an exemplary embodiment of the present disclosure, it is possible to reduce a frequency of route re-search due to positioning errors during a route guidance service by improving location estimation accuracy in a GPS shaded section. The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram schematically illustrating a configuration of a taxi service providing system according to an exemplary embodiment of the present disclosure.

FIG. 2 is a block diagram schematically illustrating a configuration of a taxi service providing system according to an exemplary embodiment of the present disclosure.

FIG. 3 is a block diagram schematically illustrating a configuration of a location information obtaining apparatus according to an exemplary embodiment of the present disclosure.

FIG. 4 is a flowchart schematically illustrating a location information obtaining method according to an exemplary embodiment of the present disclosure.

FIG. 5 is a diagram illustrating an example in which GPS information is obtained when an MMF module is activated regardless of a junction.

FIG. 6 and FIG. 7 are diagrams illustrating examples in which GPS information is obtained when the activation of the MMF module is controlled based on the junction.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to a same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments included in the present specification will be described in detail with reference to the accompanying drawings, but identical or similar components are provided the same and similar reference numerals, and overlapping descriptions thereof will be omitted. Terms “module” and “unit” for components used in the following description are used only to easily make the present disclosure. Therefore, these terms do not have meanings or roles that distinguish from each other in themselves. Furthermore, when it is decided that a detailed description for the known art related to the present disclosure may obscure the gist of the present disclosure, the detailed description thereof will be omitted. Furthermore, it may be understood that the accompanying drawings are provided only to allow exemplary embodiments of the present disclosure to be easily understood, and the spirit of the present disclosure is not limited by the accompanying drawings, but includes all the modifications, equivalents, and substitutions included in the spirit and the scope of the present disclosure.

Terms including ordinal numbers such as “first”, “second”, and the like, may be used to describe various components. However, these components are not limited by these terms. The terms are used only to distinguish one component from another component.

It will be further understood that terms “include” or “have” used in the present specification specify the presence of features, numerals, steps, operations, components, parts mentioned in the present specification, or combinations thereof, but do not preclude the presence or addition of one or more other features, numerals, steps, operations, components, parts, or combinations thereof.

In the present disclosure, each phrase such as “A or B,” “at least one of A and B,” “at least one of A or B,” “A, B, or C,” “at least one of A, B and C,” and “at least one of A, B, or C” may include any one of items listed together in the corresponding one of those phrases, or all possible combinations thereof.

A program implemented as a set of instructions embodying a control algorithm necessary for controlling other configurations may be installed in a configuration for controlling other configurations under a specific control condition among configurations according to an exemplary embodiment of the present disclosure. The control configuration may generate output information by processing input information and stored information according to an installed program. The control configuration may include a non-volatile memory for storing a program and a memory for storing information.

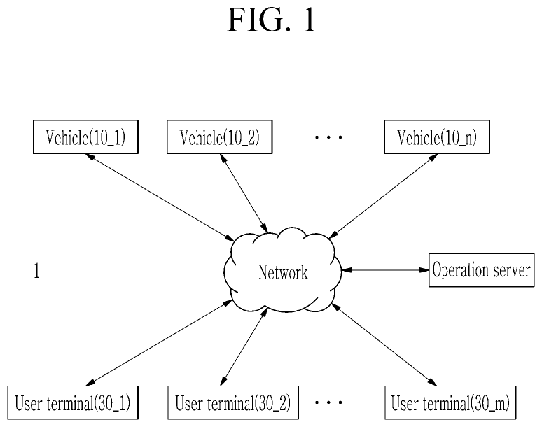

FIG. 1 is a block diagram schematically illustrating a configuration of a taxi service providing system according to an exemplary embodiment of the present disclosure.

A taxi service providing system 1 may include a plurality of vehicles 10_1 to 10_n (n is a natural number), a plurality of user terminals 30_1 to 30_m (m is a natural number), and an operation server 40.

As illustrated in FIG. 1, a plurality of vehicles 10_1 to 10_n, a plurality of user terminals 30_1 to 30_m, and an operation server 40 may transmit/receive necessary information through a network. In the instant case, the plurality of vehicles 10_1 to 10_n may be taxis operated by a driver providing a taxi service. Hereinafter, a taxi means any means of transportation that provides a service for taking a passenger to a destination and receiving a fee in return.

The operation server 40 may be a server that receives a request for a service from a plurality of user terminals 30_1 to 30_m, provides a response to the received request, and determines a vehicle to perform the service. For example, a user transmits a dispatch call to a dispatch server through the user terminal 30, and a dispatch server may transmit the received dispatch call to the plurality of vehicles 10_1 to 10_n, and receive a response to a dispatch call from the plurality of vehicles 10_1 to 10_n to perform a call dispatch. The dispatch server may determine the call dispatch, and transmit information on the dispatched vehicle to the user terminal 30. Accordingly, there may be the dispatch server as an example of the operation server 40, and the characteristics of the operation server 40 as the dispatch server will be described in the following exemplary embodiment of the present disclosure. However, the present disclosure is not limited thereto, and other types of servers for providing other services may be the operation server 40.

In an exemplary embodiment of the present disclosure, the network may be a personal area network (PAN), a local area network (LAN), a campus area network (CAN), a metropolitan area network (MAN), a wide area network (WAN), a broadband network (BBN), a wireless LAN (WLAN), a storage area network (SAN), a controller area network (CAN), and may be cellular communications such as long term evolution (LTE), LTE advanced (LTE-A), code-division multiple access (CDMA), wideband code division multiple access (WCDMA), universal mobile telecommunication system (UMTS), wireless broadband (WiBro), and Global System for Mobile Communications (GSM), but is not limited thereto.

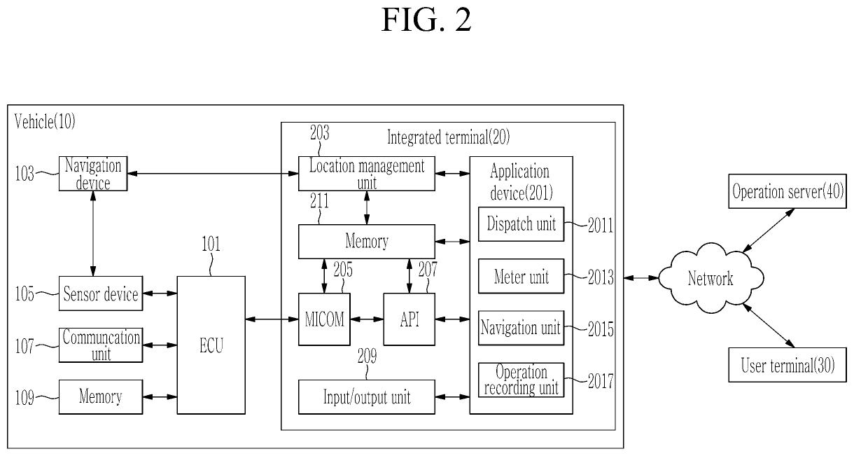

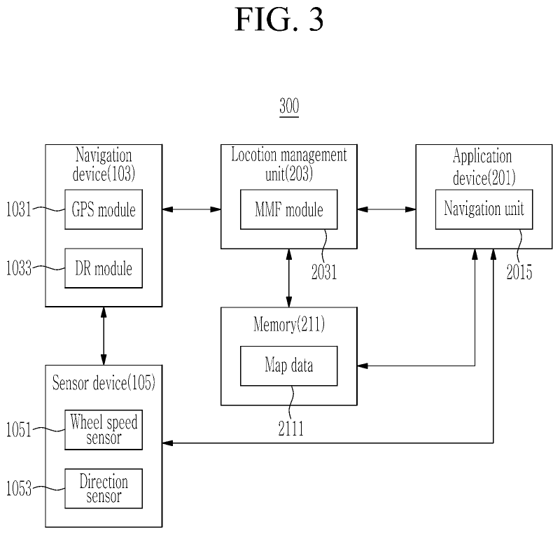

Hereinafter, the configuration of the vehicle 10 will be described with reference to FIG. 2 and FIG. 3.

FIG. 2 is a block diagram schematically illustrating the configuration of the vehicle 10 according to an exemplary embodiment of the present disclosure.

In FIG. 2, it is assumed that any one vehicle 10 transmits or receives necessary information through a network with any one user terminal 30 and the operation server 40 for description.

The vehicle 10 may include an ECU 101, a navigation device 103, a sensor device 105, a communication unit 107, a memory 109, and an integrated terminal 20.

The electronic control unit (ECU) 101 may process the information received from the sensor device 105 and transmit the processed information to the integrated terminal 20.

The navigation device 103 may obtain location information of the vehicle 10, that is, GPS information, in units of a predetermined time by use of at least one of global positioning system (GPS) navigation and dead reckoning (DR) navigation. The GPS navigation is a navigation that determines a location using GPS signals received from satellites. The DR navigation is a navigation that determines a new location of a moving object by use of a driving direction speed and direction (or attitude angle) of a moving object (e.g., the vehicle 10) based on a point whose location is already known.

When the GPS information is obtained, the navigation device 103 may transmit the GPS information to a location management unit 203. Furthermore, the navigation device 103 corrects GPS information based on map matching feedback (MMF) information received from the location management unit 203, and transmits the corrected GPS information to the location management unit 203.

The navigation device 103 may include not only GPS coordinate information but also information indicating whether the vehicle 10 enters the GPS shaded section in the GPS information and deliver the information to the location management unit 203. When the GPS signal is not received for more than a predetermined time, the navigation device 103 may conclude that the vehicle 10 enters the GPS shaded section, and then when the GPS signal is received, it may be determined that the vehicle 10 is out of the GPS shaded section.

The sensor device 105 may include a wheel speed sensor, a direction sensor, an alternator sensor, a transmission sensor, a revolution number sensor, a battery sensor, and a steering wheel sensor of the vehicle 10.

The wheel speed sensor may detect the rotation speed of the wheel of the vehicle in units of a predetermined time. The wheel speed information detected by the wheel speed sensor may match visual information and may be stored in the memory 109.

The direction sensor may detect direction information of the vehicle with respect to geomagnetism in units of a predetermined time. The direction sensor may include at least one of a gyro sensor, a geomagnetic sensor, and an acceleration sensor. The direction information detected by the direction sensor may match the visual information and may be stored in the memory 109. The alternator is a device configured for supplying electric power to a vehicle electric system by charging a battery when the engine of the vehicle 10 operates. The alternator sensor may detect whether the alternator is ON/OFF in units of a predetermined time. The ON/OFF information of the alternator detected by alternator sensor may match visual information and may be stored in the memory 109.

The transmission sensor may detect a gear state of the transmission of the vehicle in units of a predetermined time. The gear state information detected by the transmission sensor may be stored in the memory 109 by matching the visual information.

When the vehicle 10 is driven by the engine, the revolution number sensor may measure revolutions per minute (RPM) of the engine in units of a predetermined time. Furthermore, when the vehicle 10 is driven by a motor, the revolution number sensor may measure the motor rotation speed in units of a predetermined time. The rotation speed information of the engine or motor measured by the revolution number sensor may be stored in the memory 109 by matching the visual information.

The battery sensor may detect the battery state of the vehicle 10 in units of a predetermined time. The battery state information detected by the battery sensor may match the visual information and may be stored in the memory 109. The battery state information may include information on a charge rate, a voltage, a current, a temperature, a state of charge (SOC), a state of health (SOH), and the like of the battery.

The steering wheel sensor may detect information on a steering wheel, which is a steering device used to change a driving direction by moving a wheel of the vehicle 10 to the left or right. The steering wheel information detected by the steering wheel sensor may be stored in the memory 109. The steering wheel information may include information on a degree of movement of the steering wheel, whether a call button and a call end button present on the steering wheel are input, and the like.

The communication unit 107 may transmit a control command of the ECU 101 or information stored in the memory 109 to, the outside thereof, and transmit information received from the outside to the ECU 101.

The memory 109 may store information necessary for each component of the vehicle 10 to operate.

The integrated terminal 20 includes an application device 201, a location management unit 203, a MICOM 205, an API 207, an input/output unit 209, and a memory 211.

The application device 201 may include a dispatch unit 2011, a meter unit 2013, a navigation unit 2015, and an operation recording unit 2017.

The application device 201 may receive the information collected by the location management unit 203 or the sensor device 105, and use the received information to generate and transmit dispatch call information, driving fee information, navigation output screen change information, charging station guide information, or the like. In an exemplary embodiment of the present disclosure, each of the dispatch unit 2011, the navigation unit 2015, the meter unit 2013, and the operation recording unit 2017 is an application for performing a unique function, and process the allocated information and display the processing results on the input/output unit 209. Some applications may transmit the processing results to the MICOM 205 so that the processing results may be transmitted to the operation server 40. The MICOM 205 may enable the processing results to be transmitted to the operation server 40 through the ECU 101 or directly through the communication unit 107.

The dispatch unit 2011 may receive the dispatch call information, and determine whether to provide the dispatch call information to the driver according to a result of comparing the GPS information of the user terminal 30 and the heading direction information of the vehicle 10. Hereinafter, whether to provide the dispatch call information to the driver is defined as checking the dispatch call information. The dispatch call information may be transmitted from the operation server 40 to the dispatch unit 2011 through the communication unit of the vehicle 10 and the MICOM 205 of the integrated terminal 20.

When a boarding location of a user is a boarding location in the heading direction of the vehicle 10, the dispatch unit 2011 may determine to check the received dispatch call information, and transmit the dispatch call information to the input/output unit 209 so that the input/output unit 209 outputs a screen including the dispatch call information. The dispatch unit 2011 may determine the heading direction, which is the direction that the vehicle 10 is heading, through at least one of the GPS information received from the location management unit 203 and the direction information of the vehicle 10 received from the sensor device 105.

A driver may input a response of accepting or rejecting a vehicle dispatch request through the input/output unit 209, and the input/output unit 209 may generate dispatch call response information according to a driver's input, and transmit the generated call response information to the dispatch unit 2011. The dispatch unit 2011 may transmit the dispatch call response information to the MICOM 205 so that the dispatch call response information may be transmitted to the operation server 40.

The meter unit 2013 may determine the driving fee of the vehicle 10 using GPS information collected by the location management unit 203 or wheel speed information collected by the sensor device 105, and alternator information. Because the meter unit 2013 utilizes the navigation device 103 of the vehicle 10 instead of the GPS of the user terminal 30, there is an effect that more accurate fare determination may be performed through a relatively high-performance GPS.

The navigation unit 2015 may perform a normal navigation function using the GPS information received through the location management unit 203. The navigation unit 2015 may determine the current location of the vehicle 10 on the map data by matching the received GPS information to a specific location of map data including nodes and links. The navigation unit 2015 may use at least one of the received GPS information and the direction information of the vehicle 10 received from the sensor device 105 to determine the heading direction, which is the direction that the vehicle 10 is heading. The navigation unit 2015 may display the determined current location and heading direction of the vehicle 10 on the map image of the navigation screen through the input/output unit 209. The navigation unit 2015 may search for a route from an origin to a destination. When the route search is completed, the navigation unit 2015 may display the searched route information on the navigation screen through the input/output unit 209.

Also, the navigation unit 2015 may display the current location of the vehicle 10 as well as the current location of the user terminal 30 on the navigation screen. Furthermore, the navigation unit 2015 may compare the GPS information of the user terminal 30 with the GPS information and the heading direction information of the vehicle 10 to determine whether the location of the user terminal 30 is the boarding location in the heading direction of the vehicle 10. The navigation unit 2015 may display the location of the user terminal 30 on the searched route of the navigation screen through the input/output unit 209 when the location of the user terminal 30 is a boarding location in the heading direction of the vehicle 10.

The navigation unit 2015 may determine to change the navigation output screen of the vehicle when the gear is a P-stage using the gear state information, and transmit the output screen change information to the input/output unit 209 so that the input/output unit 209 outputs the change screen. Furthermore, the navigation unit 2015 may determine to output the charging station guidance information on the navigation output screen of the vehicle when the battery charge rate is less than or equal to a preset value using the battery information, and transmit the charging station guidance information to the input/output unit 209 so that the input/output unit 209 may output a charging station guidance screen.

The navigation unit 2015 may control whether the MMF function of the location management unit 203 is activated based on the GPS information received through the location management unit 203 or the current location of the vehicle 10 matched to the map data. When the vehicle 10 enters the GPS shaded section, the navigation unit 2015 may control whether the MMF function is activated according to at least one of a driving distance of the vehicle in the GPS shaded section 10 and a location in the GPS shaded section. For example, the navigation unit 2015 may maintain the MMF function in a deactivated state until the vehicle 10 enters the GPS shaded section (e.g., a tunnel, an underpass, and an underground parking lot) and drives a predetermined distance (e.g., 100 m), and activate the MMF function only when the vehicle 10 enters the GPS shaded section and then drives more than a predetermined distance. In the instant case, the driving distance of the vehicle in the GPS shaded section 10 is reset when the vehicle 10 is out of the GPS shaded section, and may be redetermined when the vehicle 10 enters a new GPS shaded section. Also, for example, when a junction exists in the GPS shaded section into which the vehicle 10 enters, the navigation unit 2015 may deactivate the MMF function when the vehicle 10 is located within a predetermined distance (e.g., 100 m) based on the junction. When the MMF function is activated, the navigation unit 2015 may transmit the route information to the location management unit 203.

The operation recording unit 2017 may record driving information such as a speed, a location, and revolutions per minute (RPM) of the vehicle 10 using the GPS information collected by the location management unit 203 or the revolution number information collected by the sensor device 105. The operation recording unit 2017 may include a digital Tacho graph (DTG).

When the vehicle 10 is driven by a motor, the operation recording unit 2017 may replace the RPM information and store the motor revolution number information received from the sensor device 105. As a result, when the vehicle is driven by the motor, it is possible to replace the RPM information and store the motor revolution number information as the operation record.

The location management unit 203 may receive GPS information from the navigation device 103 and transmit the received GPS information to the application device 201. When the MMF function is activated, the location management unit 203 may correct the GPS information received from the navigation device 103 through the map matching. That is, when the MMF function is activated, the location management unit 203 may match the current location of the vehicle 10 to a specific node and link on the map data based on the GPS information received from the navigation device 103, and obtain the corrected GPS information based on the matched result. The location management unit 203 may also transmit the MMF information including the GPS information corrected by the MMF function to the navigation device 103. When the location management unit 203 matches the current location of the vehicle 10 to a specific node and link on the map data based on the GPS information received from the navigation device 103 using the MMF function, the location management unit 203 may use the route information received from the navigation unit 2015.

The microcomputer (MICOM) 205 may transmit the information received from the ECU 101 to the application device 201 through the API 207. In the instant case, the MICOM may control the API 207 so that the information received from the ECU 101 may be transmitted to a corresponding application. The ECU 101 may transmit the information collected by the sensor device 105 to the MICOM 205 through the CAN communication, and the MICOM 205 may transmit the collected information from the application device 201 to the corresponding application through the API 207. That is, the MICOM 205 may classify the received information and allocate the classified information to an application for processing the information received through the API 207.

The application programming interface (API) 207 may perform communication between the ECU 101 and the application device 201. For example, the ECU 101 may transmit the information collected by the sensor device 105 to the application device 201 through the API 207.

The input/output unit 209 may generate the input information for controlling the operation of the integrated terminal 20, and output an audio signal (or a signal related to hearing), a video signal (or a signal related to vision), an alarm signal, or a signal related to a tactile signal. For example, the input/output unit 209 may be a touch display or the like.

The memory 211 may store information necessary for each component of the integrated terminal 20 to operate. For example, the memory 211 may store map data used in the navigation unit 2015 and the location management unit 203.

The user terminal 30 may be a mobile terminal such as a mobile phone, a smart phone, or a notebook computer. A user may be an occupant using a taxi service.

In the following description, transmitting and receiving the information to the operation server 40 by the configuration implemented as one application of the application device 201 may be performed through the communication unit 107 of the vehicle 10. That is, the information received from the operation server 40 to the communication unit 107 may be transmitted to the corresponding application through the ECU 101, the MICOM 205, and the API 207, and the information generated in the application may be transmitted to the operation server 40 through the API 207, the MICOM 205, the ECU 101, and the communication unit 107. However, the present disclosure is not limited thereto, and the direct communication between the application device 201 and the communication unit 107 may be possible.

FIG. 3 is a block diagram schematically illustrating a configuration of a location information obtaining apparatus of a vehicle according to an exemplary embodiment of the present disclosure.

Referring to FIG. 3, the location information obtaining apparatus 300 may include the navigation device 103 and the sensor device 105 mounted on the vehicle 10, a navigation unit 2015 of the integrated terminal 20, the location management unit 203, and the memory 211.

The navigation device 103 may include a GPS module 1031 and a DR module 1033.

The GPS module 1031 may receive a GPS signal from a satellite and obtain the location information of the vehicle 10, that is, the GPS information, using the received GPS signal.

The DR module 1033 may obtain the speed information of the vehicle 10 from the wheel speed information detected through a wheel speed sensor 1051 of the sensor device 105, and obtain the direction information of the vehicle 10 from the direction information detected through the direction sensor 1053. Furthermore, the DR module 1033 may correct and output the GPS information obtained by the GPS module 1031 using the speed information and direction information of the vehicle 10.

When the GPS information of the vehicle 10 is requested, the navigation device 103 may obtain the GPS information using at least one of the GPS module 1031 and the DR module 1033.

For example, the navigation device 103 may determine whether the vehicle 10 enters the GPS shaded section according to whether the GPS signal is received, and use the GPS module 1031 or the DR module 1033 based on the determination result to obtain the GPS information.

When it is determined that the vehicle 10 is driving in an open space rather than the GPS shaded section, the navigation device 103 may obtain the GPS information using only the GPS module 1031.

When it is determined that the vehicle 10 enters the GPS shaded section, the navigation device 103 may obtain the GPS information using only the DR module 1033. In the instant case, the DR module 1033 may use the speed information and the direction information of the vehicle 10 based on the GPS information last obtained through the GPS module 1031 before entering the GPS shaded section, determining new location information (GPS information) of the vehicle. That is, in the first determination performed after entering the GPS shaded section, the DR module 1033 may correct the last GPS information determined using the GPS signal by use of the speed information and direction information of the vehicle 10, obtaining new GPS information. Then, the DR module 1033 may obtain new GPS information by correcting the GPS information immediately output by the DR module 1033 from the next determination using the speed information and direction information of the vehicle 10.

When it is determined that the vehicle 10 is driving in an open space, the navigation device 103 may obtain the GPS information using the GPS module 1031 and the DR module 1033. In the instant case, the GPS module 1031 may obtain the GPS information of the vehicle 10 based on the received GPS signal, and the DR module 1033 may correct and output the GPS information obtained by the GPS module 1031 based on the speed information and direction information of the vehicle 10.

As described above, when the GPS information is obtained by at least one of the GPS module 1031 and the DR module 1033, the navigation device 103 may transmit the GPS information to the location management unit 203.

When the MMF information including the corrected GPS information is received from the location management unit 203, the DR module 1033 may correct and output the GPS information determined by the DR module 1033 using the received MMF information. For example, the DR module 1033 may determine the corrected GPS information from the GPS information determined by the DR module 1033 and the GPS information fed back from the location management unit 203 using an interpolation method, an averaging method, or the like. Also, for example, the DR module 1033 may select any one of the GPS information determined by the DR module 1033 based on the information received from the sensor device 105 and the GPS information fed back from the location management unit 203, and output the selected GPS information as the corrected GPS information. In the instant case, the navigation device 103 may transmit the GPS information corrected based on the MMF information received from the location management unit 203 back to the location management unit 203.

The location management unit 203 may include an MMF module 2031. The location management unit 203 may control whether the MMF module 2031 is activated based on a control input received from the navigation unit 2015 of the application device 201.

When the MMF module 2031 is in a deactivated state, the location management unit 203 may transmit the GPS information received from the navigation device 103 to the navigation unit 2015 without correction using the MMF module 2031.

When the MMF module 2031 is activated, the location management unit 203 may transmit the GPS information received from the DR module 1033 of the navigation device 103 to the MMF module 2031. The MMF module 2031 receiving the GPS information may correct the GPS information received through the map matching using the map data 2111 stored in the memory 211. That is, the MMF module 2031 may correct the GPS information by matching a node and a link adjacent to a location indicated by the GPS information received from the DR module 1033 among nodes and links on the map data 2111. When the route information is received from the navigation unit 2015, the MMF module 2031 may perform the map matching based on the route information. For example, when the MMF module 2031 matches the GPS information received from the navigation device 103 on the map data 2111, the MMF module 2031 may perform the map matching to preferentially match the nodes and links included in the route information. When the GPS information is corrected through the map matching, the MMF module 2031 may feedback the MMF information including the corrected GPS information to the DR module 1033.

After the GPS information corrected by the MMF module 2031 is transmitted to the DR module 1033, the DR module 1033 may correct the received GPS information. When receiving the GPS information corrected by the DR module 1033, the location management unit 203 may transmit the received GPS information to the navigation unit 2015 of the application device 201.

The navigation unit 2015 may check whether the vehicle 10 enters the GPS shaded section such as a tunnel, an underpass, or an underground parking lot based on the GPS information received through the location management unit 203 and the map data stored in the memory 211. Furthermore, the navigation unit 2015 may determine the speed of the vehicle 10 based on the wheel speed information collected through the sensor device 105, and determine the moving distance of the vehicle 10 based on the determined speed. When the vehicle 10 enters the GPS shaded section, the navigation unit 2015 may control whether the MMF function is activated according to at least one of a driving distance of the vehicle in the GPS shaded section 10 and a location in the GPS shaded section. When it is determined that the vehicle 10 has moved a predetermined distance (e.g., 100 m) or more within the GPS shaded section after the vehicle 10 enters the GPS shaded section, the navigation unit 2015 may activate the MMF module 2031 through the location management unit 203. The navigation unit 2015 may also deactivate the MMF module 2031 through the location management unit 203 when it is determined that the vehicle 10 is out of the GPS shaded section.

The navigation unit 2015 may also check whether the junction is located in the GPS shaded section where it is determined that the vehicle 10 has entered based on the map data 2111. When the GPS shaded section into which the vehicle 10 enters includes a junction, the navigation unit 2015 may determine a relative distance between the junction and the vehicle 10 based on the current location of the vehicle 10 and the location of the junction matched in the map data 2111. When the vehicle 10 is located within a predetermined distance (e.g., 100 m) from the junction of the tunnel or the underpass, the navigation unit 2015 may deactivate the MMF module 2031 through the location management unit 203.

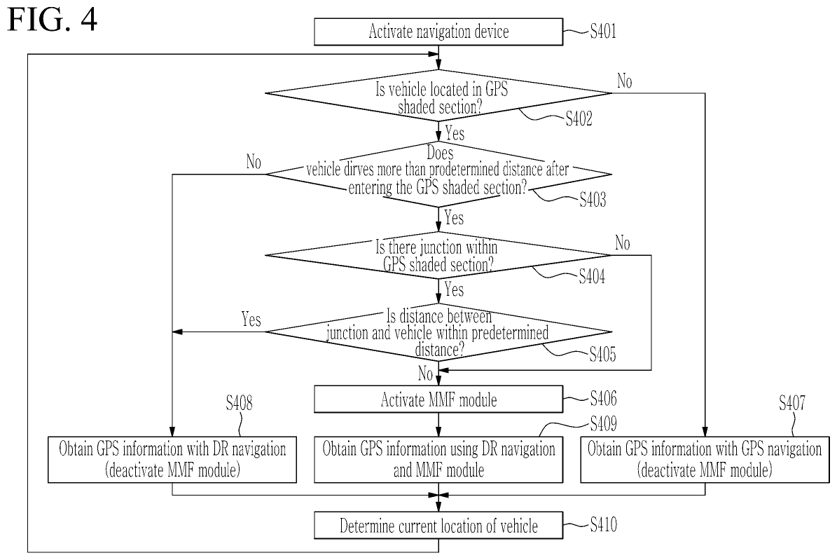

FIG. 4 is a flowchart schematically illustrating a location information obtaining method according to an exemplary embodiment of the present disclosure. The location information obtaining method of FIG. 4 may be performed by the location information obtaining apparatus 300 of the vehicle 10 described with reference to FIG. 2 and FIG. 3.

Referring to FIG. 4, when the navigation device 103 is activated (S401), the location information obtaining apparatus 300 may determine whether the vehicle 10 is located in the GPS shaded section such as a tunnel, an underpass, or an underground parking lot based on the GPS information obtained through the navigation device 103 and the map data stored in the memory 211 (S402).

When it is determined that the vehicle 10 is located in an open space rather than the GPS shaded section in step S402, the location information obtaining apparatus 300 may obtain the GPS information of the vehicle 10 by the GPS navigation (S407). That is, the location information obtaining apparatus 300 may obtain the GPS information corresponding to the current location of the vehicle 10 through the GPS module 1031 of the navigation device 103.

When it is determined that the vehicle 10 is located in the GPS shaded section in step S402, the location information obtaining apparatus 300 may check whether the vehicle 10 has driven more than a predetermined distance after entering the GPS shaded section (S403). Furthermore, the location information obtaining apparatus 300 checks whether a junction exists within the GPS section into which the vehicle 10 enters (S404), and when there is a junction within the GPS shaded section, it may be checked whether the distance between the junction and the vehicle 10 is within a predetermined distance (S405).

When it is checked that the driving distance of the vehicle 10 after the vehicle 10 enters the GPS shaded section through step S403 is less than a predetermined distance (e.g., 100 m), the location information obtaining apparatus 300 may obtain the GPS information of the vehicle 10 by the DR navigation (S408). That is, the location information obtaining apparatus 300 may obtain the GPS information corresponding to the current location of the vehicle 10 through the GPS module 1033 of the navigation device 103. In the instant case, the MMF module 2031 of the location management unit 203 may be controlled in the deactivated state.

Although the location information obtaining apparatus 300 confirms that the vehicle 10 has driven more than a predetermined distance after entering the GPS shaded section through step S403, it is checked that junction exists in the GPS shaded section through step S404 and checked that the distance between the junction and the vehicle 10 is within a predetermined distance (e.g., 100 m) through step S405, the GPS information of the vehicle 10 may be obtained by the DR navigation (S408). In the instant case, the MMF module 2031 of the location management unit 203 may be controlled in the deactivated state.

When it is determined that the junction does not exist within the GPS shaded section through step S404, or it is checked that the distance between the junction and the vehicle 10 is greater than the predetermined distance through step S405 in the state in which it is checked that the vehicle 10 drives more than a predetermined distance after entering the GPS shaded section through step S403, the location information obtaining apparatus 300 may activate the MMF module of the location management unit 203 (S406). Furthermore, the location information obtaining apparatus 300 may obtain the GPS information corresponding to the current location of the vehicle 10 by use of the DR navigation and MMF module 2031 (S409). That is, when the location information obtaining apparatus 300 corrects the GPS information output from the DR module 1033 using the MMF module 2031 and feeds the corrected GPS information back to the DR module 1033, and then outputs the GPS information corrected using the GPS information fed back from the DR module 1033, the location information obtaining apparatus 300 may obtain the output GPS information as the GPS information corresponding to the current location of the vehicle 10.

When the GPS information is obtained through steps S407, S408, or S409, the location information obtaining apparatus 300 matches the corresponding GPS information with the map data 2111 through the navigation unit 2015 to determine the current location of the vehicle 10 (S410).

The location information obtaining apparatus 300 may repeatedly perform steps S402 to S410 described above until the starting of the vehicle 10 is turned off, the navigation device 103 is deactivated, or the navigation unit 2015 is deactivated.

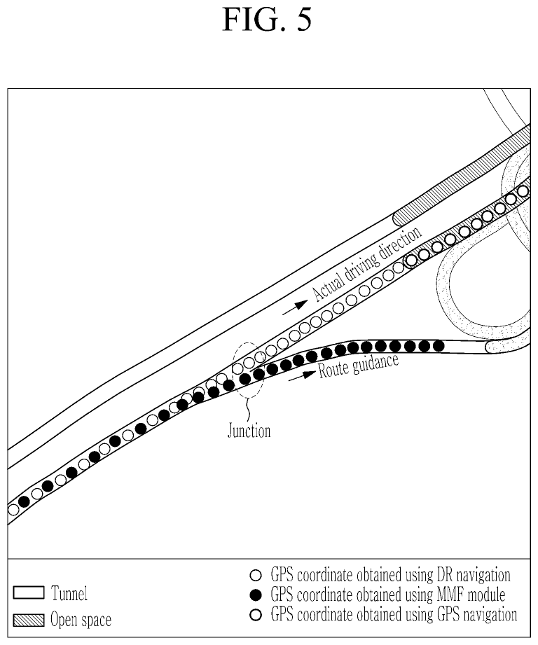

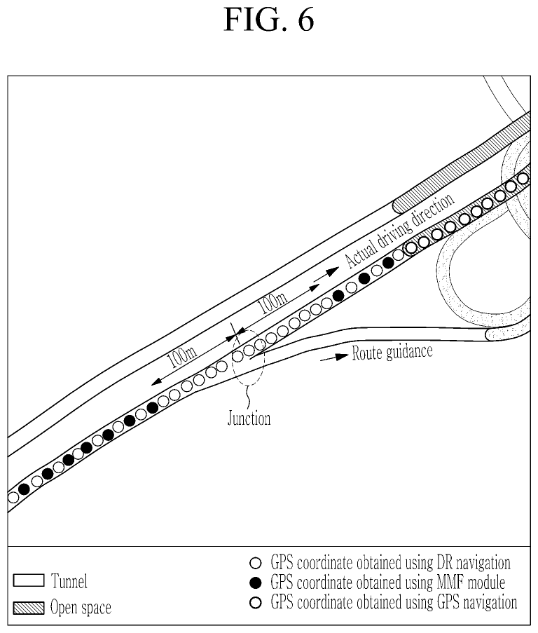

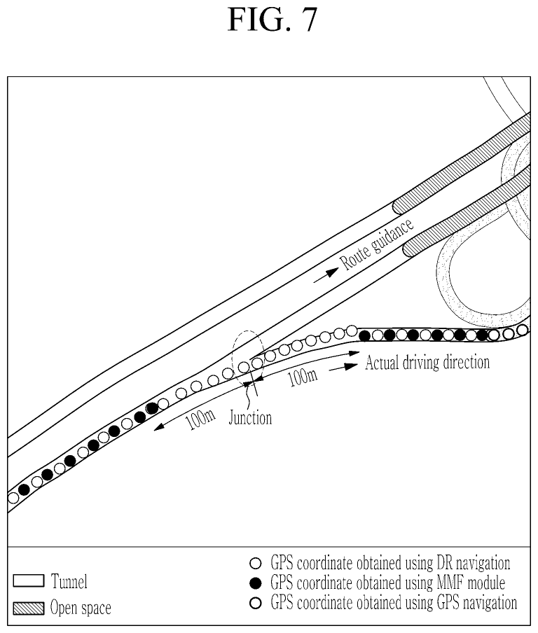

Hereinafter, effects of the above-described location information obtaining apparatus 300 will be described with reference to FIG. 5, FIG. 6 and FIG. 7.

FIG. 5 shows an example in which the GPS information is obtained when the MMF module 2031 is activated regardless of the junction. Furthermore, FIG. 6 and FIG. 7 illustrate examples in which the GPS information is obtained when the activation of the MMF module 2031 is controlled based on the junction.

FIG. 5 illustrates an example in which the vehicle 10 drives in a straight lane in a situation in which the route guidance information of the navigation unit 2015 instructs to drive in a ramp lane in the junction. In FIG. 5, the MMF module 2031 corrects the GPS information determined by the DR module 1033 based on the route guidance information to a ramp lane instead of a straight lane. Accordingly, the DR module 1033 that has received the MMF information from the MMF module 2031 finally outputs the corrected GPS information as a point between the straight lane and the ramp lane based on the GPS information corrected by the MMF module 2031, so that the vehicle 10 is out of the current location.

FIG. 6 illustrates, as an exemplary embodiment of the present disclosure, a case in which the vehicle 10 drives in a straight lane in a situation in which the route guidance information of the navigation unit 2015 instructs to drive in a ramp lane at the junction, and FIG. 7 illustrates, as an exemplary embodiment of the present disclosure, a case in which the vehicle 10 drives to the ramp lane when the route guidance information of the navigation unit 2015 instructs to drive in the straight lane at the junction. In FIG. 6 and FIG. 7, the MMF module 2031 maintains the deactivated state in a section within 100 m before and after the junction, and the GPS information determined by the DR module 1033 is used without correction in the corresponding section. Accordingly, even when the vehicle 10 drives in a lane different from the route guidance of the navigation unit 2015 at the junction, it is possible to prevent an error in which the GPS information of the vehicle 10 is determined to point to an incorrect location. Furthermore, even when the vehicle 10 is out of the route, the navigation unit 2015 may immediately check the lane in which the vehicle 10 is driving, so that a quick route re-search is possible, and unnecessary route re-search due to the deviation from the current location may be prevented.

In addition to the above-described effects, the location information obtaining apparatus 300 according to various exemplary embodiments of the present disclosure may deactivate the GPS correction using the MMF module 2031 for a predetermined section after the vehicle 10 enters the GPS shaded section, and thus, may prevent errors such as map matching the GPS information of the vehicle 10 to the underpass when the vehicle 10 enters the underground parking lot right next to the underpass.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A location information obtaining apparatus of a vehicle, the location information obtaining apparatus comprising:
a navigation device configured to obtain first global positioning system (GPS) information using at least one of a GPS navigation using a GPS signal and a dead reckoning (DR) navigation using speed information and direction information of the vehicle;
a map matching feedback module configured to feedback second GPS information generated by map matching between the first GPS information and map data to the navigation device; and
an application device configured to determine a current location of the vehicle based on the first GPS information received from the navigation device,
wherein an activation of the map matching feedback module is controlled according to a location in a GPS shaded section of the vehicle or a driving distance of the vehicle in the GPS shaded section, and
wherein the navigation device is further configured to generate third GPS information using the first GPS information and the second GPS information when the map matching feedback module is activated, and transmit one of the first GPS information and the third GPS information to the application device according to whether the map matching feedback module is activated.

2. The location information obtaining apparatus of claim 1, wherein the map matching feedback module is further configured to be activated when the vehicle enters the GPS shaded section and then drives more than a predetermined distance within the GPS shaded section, and configured to be deactivated when the vehicle is out of the GPS shaded section.

3. The location information obtaining apparatus of claim 2, wherein the navigation device is further configured to use the DR navigation to obtain the first GPS information when the vehicle enters the GPS shaded section.

4. The location information obtaining apparatus of claim 3, wherein when the map matching feedback module is activated, the navigation device is further configured to obtain the third GPS information by correcting the first GPS information using the second GPS information, and configured to transmit the third GPS information to the application device.

5. The location information obtaining apparatus of claim 3, wherein the navigation device is further configured to transmit the first GPS information to the application device when the map matching feedback module is deactivated.

6. The location information obtaining apparatus of claim 1, wherein the application device is further configured to determine the current location of the vehicle on the map data by map matching between the first GPS information received from the navigation device and the map data.

7. The location information obtaining apparatus of claim 6, wherein the application device is configured to determine whether the vehicle enters the GPS shaded section and the driving distance driven by the vehicle within the GPS shaded section based on the GPS information and the map data received from the navigation device.

8. The location information obtaining apparatus of claim 6, wherein the activation of the map matching feedback module is controlled according to presence or absence of a junction in the GPS shaded section and a distance between the vehicle and the junction.

9. The location information obtaining apparatus of claim 8, wherein the map matching feedback module is configured to be deactivated when the junction exists in the GPS shaded section and the vehicle is located within a predetermined distance from the junction.

10. The location information obtaining apparatus of claim 8, wherein the application device is configured to determine whether the junction exists in the GPS shaded section based on the first GPS information received from the navigation device and the map data, and configured to determine the distance between the junction and the vehicle.

11. The location information obtaining apparatus of claim 1, further including:
a sensor device configured to detect wheel speed and direction of the vehicle,
wherein the navigation device is configured to obtain speed information and direction information of the vehicle based on information detected by the sensor device.

12. The location information obtaining apparatus of claim 1, wherein the GPS shaded section is a tunnel or an underpass section.

13. A taxi service providing system, comprising:
the location information obtaining apparatus of claim 1,
wherein the application device and the map matching feedback module are configured to be included in an integrated terminal of the taxi service providing system, and
wherein the integrated terminal is configured to be connected to, through a network, an operation server that provides a response to a request for a service received from a user terminal, determine whether to check dispatch call information by use of information linking a driving state of the vehicle, a user's boarding location, and heading direction information of the vehicle, determine a driving fee by use of GPS information or wheel speed information of the vehicle, and determine whether to change an output screen of the vehicle through gear state information of the vehicle.

14. A location information obtaining method of a vehicle, the location information obtaining method comprising:
obtaining first global positioning system (GPS) information using at least one of a GPS navigation using a GPS signal and a dead reckoning (DR) navigation using speed information and direction information of the vehicle;
controlling an activation of a map matching feedback module that generates second GPS information by map matching of the first GPS information and map data according to a location in a GPS shaded section of the vehicle or a driving distance of the vehicle in the GPS shaded section;
when the map matching feedback module is activated, generating third GPS information using the first GPS information and the second GPS information; and
determining a current location of the vehicle by use of one of the first GPS information and the third GPS information according to whether the map matching feedback module is activated.

15. The location information obtaining method of claim 14, wherein the obtaining of the first GPS information includes:
when the vehicle is located in the GPS shaded section, obtaining the first GPS information using the DR navigation.

16. The location information obtaining method of claim 14, wherein the obtaining of the first GPS information includes:
when the vehicle is located outside the GPS shaded section, obtaining the first GPS information using the GPS navigation.

17. The location information obtaining method of claim 14, wherein the controlling of the activation includes:
activating the map matching feedback module when the vehicle is located in the GPS shaded section and the driving distance driven by the vehicle within the GPS shaded section is greater than or equal to a predetermined distance; and
when the vehicle is located outside the GPS shaded section, deactivating the map matching feedback module.

18. The location information obtaining method of claim 14, further including:
deactivating the map matching feedback module according to presence or absence of a junction in the GPS shaded section and a distance between the vehicle and the junction.

19. The location information obtaining method of claim 18, wherein the deactivating includes:
deactivating the map matching feedback module when the junction exists in the GPS shaded section and the vehicle is located within a predetermined distance from the junction.

20. The location information obtaining method of claim 14, wherein the determining of the current location includes:
determining the current location of the vehicle on the map data through the map matching of the map data with one of the first GPS information and the third GPS information.
